(19) United States
(12) Patent Application Publication
(10) Pub. No.: US 2026/0089487 A1
(43) Pub. Date: Mar. 26, 2026

(54) UPDATING OF PRE-GENERATED ESIM PROFILES

(71) Applicant: RAKUTEN SYMPHONY, INC., Tokyo (JP)

(72) Inventor: Ashutosh GUPTA, Bangalore (IN)

(73) Assignee: RAKUTEN SYMPHONY, INC., Tokyo (JP)

(21) Appl. No.: 19/036,441

(22) Filed: Jan. 24, 2025

(30) Foreign Application Priority Data
Sep. 25, 2024 (IN) 202411072441

(51) Int. Cl. H04W 8/18; H04W 8/20; H04W 12/72

(52) U.S. Cl. CPC H04W 8/183; H04W 8/205; H04W 12/72

(57) ABSTRACT

Disclosed is an apparatus (600) configured to generate a plurality of embedded Subscriber Identity Module (eSIM) profiles based on one or more preconfigured parameters. The apparatus (600) is configured to receive, from an operator entity (108), an update order function including at least one of a file ID, a profile type, an ICCID number, a home IMSI number, a roaming IMSI number, and a MSISDN. Thereafter, the apparatus (600) is configured to validate the at least one of the file ID, the ICCID number, the profile type, the home IMSI number, the roaming IMSI number, and the MSISDN number. In response to a successful validation, the apparatus (600) is configured to update one of eSIM profile with the at least one of the file ID, the ICCID number, the home IMSI number, the roaming IMSI number, and the MSISDN number.

### CROSS REFERENCE TO RELATED APPLICATION(S)

This application claims priority based on India Patent Application No. 202411072441 filed Sep. 25, 2024, the entire disclosure of which is incorporated by reference herein.

### FIELD

The present disclosure relates to the updating of pre-generated embedded Subscriber Identity Module (eSIM) profiles.

### BACKGROUND

The information disclosed in this background section is only for the enhancement of understanding of the general background of the disclosure and should not be taken as an acknowledgment or any form of suggestion that this information forms the prior art already known to a person skilled in the art.

An embedded Subscriber Identity Module (eSIM), also referred to as an embedded Universal Integrated Circuit Card (eUICC), is a small, programmable chip that can be embedded directly into devices like smartphones, tablets, smartwatches, and Internet of Things (IoT) devices. Unlike traditional SIM cards, which are physical and removable, the eSIMs are integrated into the device's hardware, offering a more streamlined and flexible solution for mobile connectivity.

An e-SIM module implemented at a User Equipment (UE) may store multiple eSIM profiles or subscriptions, allowing users to switch between different mobile network operators or plans without any need to change the SIM card manually. However, such eSIM profiles are pre-personalized, therefore switching from a physical SIM to an eSIM is an expensive operation.

### SUMMARY

This summary is provided to introduce a selection of concepts, in a simplified format, that are further described in the detailed description of the disclosure. This summary is neither intended to identify key or essential inventive concepts of the disclosure nor is it intended to determine the scope of the disclosure.

Disclosed herein is an apparatus. The apparatus is configured to generate a plurality of embedded Subscriber Identity Module (eSIM) profiles based on one or more preconfigured parameters. The apparatus is also configured to receive, from an operator entity, an update order function. The update order function includes at least one of a file Identifier (ID), a profile type, an Integrated Circuit Card Identification (ICCID) number, a home International Mobile Subscriber Identity (IMSI) number, a roaming IMSI number, and a Mobile Station International Subscriber Directory Number (MSISDN). In response to the received update order function, the apparatus is configured to validate one or more of the file ID, the ICCID number, the profile type, the home IMSI number, the roaming IMSI number, and the MSISDN number. The validation is based on at least one of the one or more preconfigured parameters and one or more predetermined criteria associated with the plurality of generated eSIM profiles. In response to a successful validation, the apparatus is configured to update one of the plurality of generated eSIM profiles with one or more of the file ID, the ICCID number, the home IMSI number, the roaming IMSI number, and the MSISDN number.

Disclosed herein is a method. The method includes generating a plurality of embedded Subscriber Identity Module (eSIM) profiles based on one or more preconfigured parameters. The plurality of eSIM profiles are being generated by a Subscription Manager Data Preparation (SM-DP+) server. The method also includes receiving, by the SM-DP+ server from an operator entity, an update order function. The update order function includes at least one of a File Identifier (ID), an Integrated Circuit Card Identification (ICCID) number, a home International Mobile Subscriber Identity (IMSI) number, a roaming IMSI number, and a Mobile Station International Subscriber Directory Number (MSISDN). In response to the received update order function, the method also includes validating, by the SM-DP+ server, the at least one of the file ID, the ICCID number, the home IMSI number, the roaming IMSI number, and the MSISDN number. The validation is based on at least one of the one or more preconfigured parameters and one or more predetermined criteria associated with the plurality of generated eSIM profiles. In response to a successful validation, the method includes updating, by the SM-DP+ server, one of the plurality of generated eSIM profiles with the at least one of the file ID, the ICCID number, the home IMSI number, the roaming IMSI number, and the MSISDN number.

Disclosed herein is a non-transitory computer-readable medium storing instructions. The instructions comprising one or more instructions that are executed by a Subscription Manager Data Preparation (SM-DP+) server. The instructions cause the one or more processors to generate a plurality of embedded Subscriber Identity Module (eSIM) profiles based on one or more preconfigured parameters. The instructions cause the one or more processors to receive an update order function from an operator entity. The update order function includes at least one of a file Identifier (ID), an Integrated Circuit Card Identification (ICCID) number, a home International Mobile Subscriber Identity (IMSI) number, a roaming IMSI number, and a Mobile Station International Subscriber Directory Number (MSISDN). In response to the received update order function, the instructions cause the one or more processors to validate the at least one of the file ID, the ICCID number, the home IMSI number, the roaming IMSI number, and the MSISDN number. The validation is based on at least one of the one or more preconfigured parameters and one or more predetermined criteria associated with the plurality of generated eSIM profiles. In response to a successful validation, the instructions cause the one or more processors to update one of the plurality of generated eSIM profiles with the at least one of the file ID, the ICCID number, the home IMSI number, the roaming IMSI number, and the MSISDN number.

To further clarify the advantages and features of the present disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 illustrates a schematic embedded-Subscriber Identity Module (eSIM) architecture, according to a conventional technique;

FIGS. 2A-2C illustrate a signaling diagram depicting a method of provisioning of eSIM profiles, in accordance with an embodiment of the present disclosure;

FIG. 3 illustrates a flow diagram illustrating e-SIM profile state transitions during transferring of the e-SIM profile, according to an embodiment of the present disclosure;

FIG. 4 illustrates a schematic operational flow diagram depicting an eSIM profile update, in accordance with an embodiment of the present disclosure;

FIG. 5 illustrates a flowchart depicting a method for updating a pre-generated eSIM profile, in accordance with an embodiment of the present disclosure; and

FIG. 6 is a diagram of example components of a wireless communication device, in accordance with an embodiment of the present disclosure.

### DETAILED DESCRIPTION

The following detailed description of example embodiments refers to the accompanying drawings. The present disclosure provides illustrations and descriptions, but is not intended to be exhaustive or to limit the implementations to the precise form disclosed. Modifications and variations are possible in light of the present disclosure or may be acquired from the practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

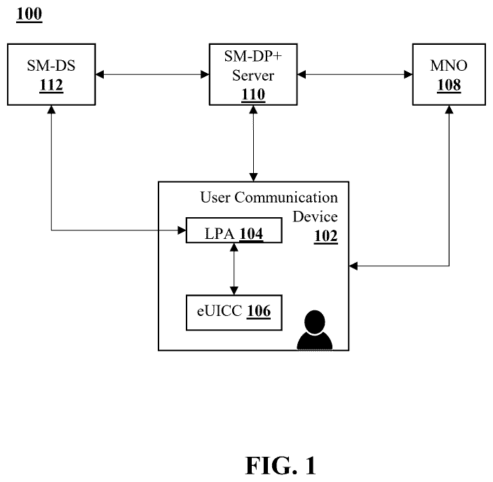

FIG. 1 illustrates a schematic embedded-Subscriber Identity Module (eSIM) architecture 100 (also referred to as “the architecture 100”), according to a conventional technique. The architecture 100 may include an eSIM-enabled communication device 102, a Mobile Network Operator (MNO) 108 (also referred to as “an operator entity 108”), a Subscription Manager Data Preparation (SM-DP+) server 110 (also referred to as the SM-DP+ 110), a Subscription Manager Discovery Server (SM-DS) 112. The user communication device 102 may include a Local Profile Assistant (LPA) 104 and an embedded Universal Integrated Circuit Card (eUICC) 106.

The LPA 104 may be referred to as a set of functions in the user communication device 102 that is responsible for providing the capability to download encrypted eSIM profiles to the eUICC 106. The LPA 104 may provide a local management end-user interface to an end user so that the end user can manage statutes of the installed profiled on the eUICC 106. The eUICC 106 may be configured to accommodate multiple eSIM profiles. Further, each eSIM profile may include operator and subscriber data similar to the data stored in a conventional physical SIM. The eSIM profiles may be remotely downloaded Over-The-Air (OTA) into the eUICC 106. The MNO 108 may correspond to a network entity connected with an operator's network. The MNO 108 may enable the operator to provide eSIM profiles to the end user via the SM-DP+ server 110 and the SM-DS 112.

The SM-DP+ server 110 may be responsible for preparing, storing, and protecting eSIM profiles corresponding to the operator. The SM-DP+ server 110 may also store authentical credentials associated with the operator.

The SM-DS 112 may act as an interface between the SM-DP+ server 110 and the eUICC 106. The SM-DS 112 may be configured to notify the LPA 104 when the eSIM profile data is available for download to the eUICC 106. An example eSIM activation process may be explained as follows:

Initially, the end user of the e-SIM-enabled communication device 102 connects to the MNO 108 to subscribe to a plan for an e-SIM. Examples of the communication device 102 may include, but are not limited to, a smartphone, a tablet, a laptop, a smartwatch, an Internet of Things (IoT) based device, and the like. Thereafter, the MNO 108 may scan an Embedded Identity Document (EID) number (also referred to as the EID) corresponding to the user communication device 102 either from a packaging box of the communication device 102 and/or from a Graphical User Interface (GUI) displayed by the communication device 102.

The MNO 108 may then transmit a request for an e-SIM profile and a registration of an event to the SM-DS 112 via the SM-DP+ server 110. The MNO 108 may also transmit information such as, but not limited to, the EID of the user communication device 102, an Integrated Circuit Card Identifier (ICCID), a home International Mobile Subscriber Identity (IMSI), a roaming IMSI, etc.

Thereafter, the SM-DP+ server 110 may register the event for the EID with the SM-DS 112. Specifically, during the provisioning of the e-SIM, various events may occur at the SM-DS 112. Examples of such events may include, but are not limited to, profile download requests, profile validation, profile selection, profile preparation, profile provisioning, profile installation, and so forth. The registration of the event may indicate activation of any of the aforementioned events at the SM-DS 112.

Further, the LPA 104 which is implemented at the user communication device 102 may submit the EID corresponding to the user communication device 102 to the SM-DS 112 and requests the SM-DS 112 for corresponding event information. In response, the SM-DS 112 may transmit an event ID and/or event information associated with the event registered for the corresponding EID. Based on the event ID and/or the event information, the user communication device 102 may determine that the e-SIM profile corresponding to the EID of the communication device 102 is ready to install.

Thereafter, the user communication device 102 may download the e-SIM profile from the SM-DP+ server 110 using the received event ID. Lastly, the user communication device 102 may install the downloaded e-SIM profile. Specifically, the user communication device 102 may configure the eUICC 106 with the information included in the downloaded e-SIM profile. The eUICC 106 may be configured to implement the e-SIM functionality at the user communication device 102 using the information associated with the downloaded e-SIM profile. The eUICC 106 may be referred to as a programmable SIM card that is embedded within the user communication device 102. The eUICC 106 may enable remote provisioning and management of multiple MNO profiles at the user communication device 102.

However, whenever a customer decides to switch from a physical SIM to an eSIM, the operator cannot reuse an existing IMSI (including both Home and Roaming IMSI) for the new pre-personalized eSIM profile. Therefore, the operator must acquire a new IMSI from the government for each switch, which introduces a cost factor for every transition.

Moreover, the operators place orders for batches of eSIM profiles on the SM-DP+ server based on different telecom circles. Accordingly, IMSIs are allocated based on these telecom circles. However, if a particular telecom circle runs out of an eSIM profile, it becomes difficult for the operator to issue a new eSIM profile within that telecom circle. Also, the operators are unable to use a pre-personalized eSIM profile corresponding from one telecom circle to another telecom circle. This leads to inefficient utilization of resources.

Furthermore, whenever eSIM profiles are generated, the operator does not assign a Mobile Station International Subscriber Directory Number (MSISDN) directly. The MSISDN is updated on the eSIM profile through an OTA (Over-The-Air) server after successful authentication with the mobile network. However, a significant drawback of using the OTA servers is their success rate, which for OTA campaign updates, is approximately 70-80%. Consequently, there is a chance that the MSISDN may not be updated following the activation of the eSIM by the end user and the end user fails to get the services. This led to a bad user experience with the network.

The present disclosure provides a solution to one or more of the above-mentioned problems by enabling dynamic updates of the eSIM profiles during provisioning/ordering of the eSIM profiles.

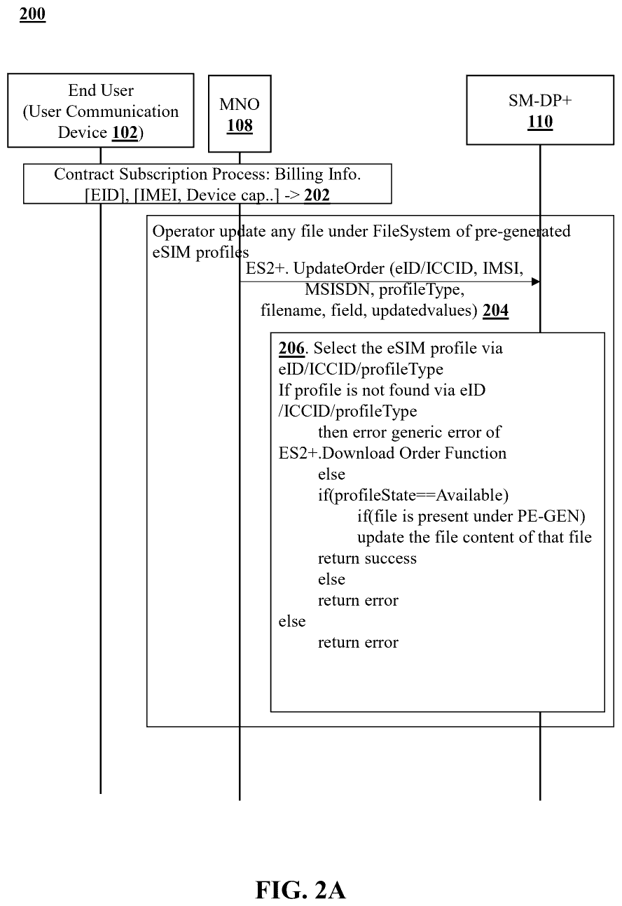

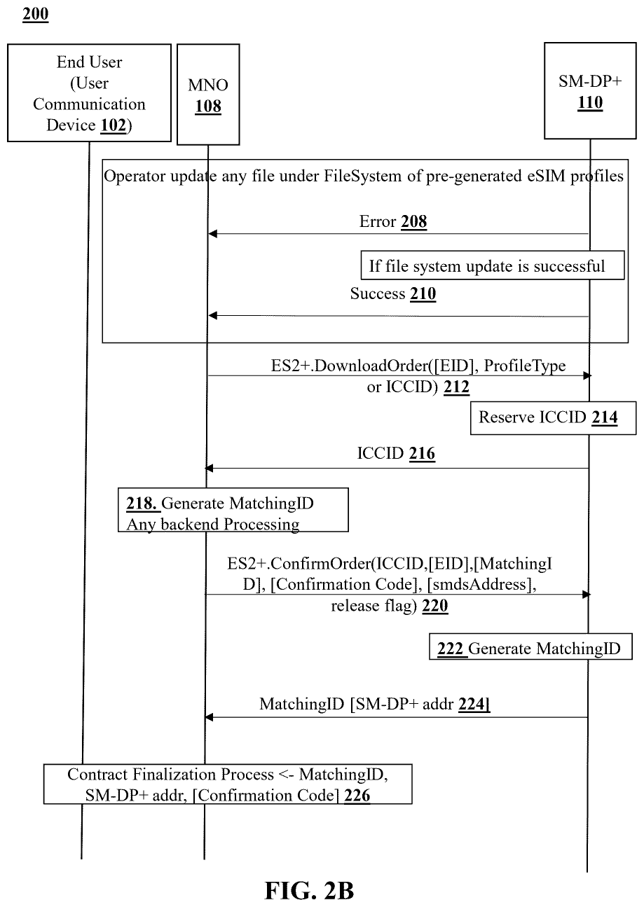

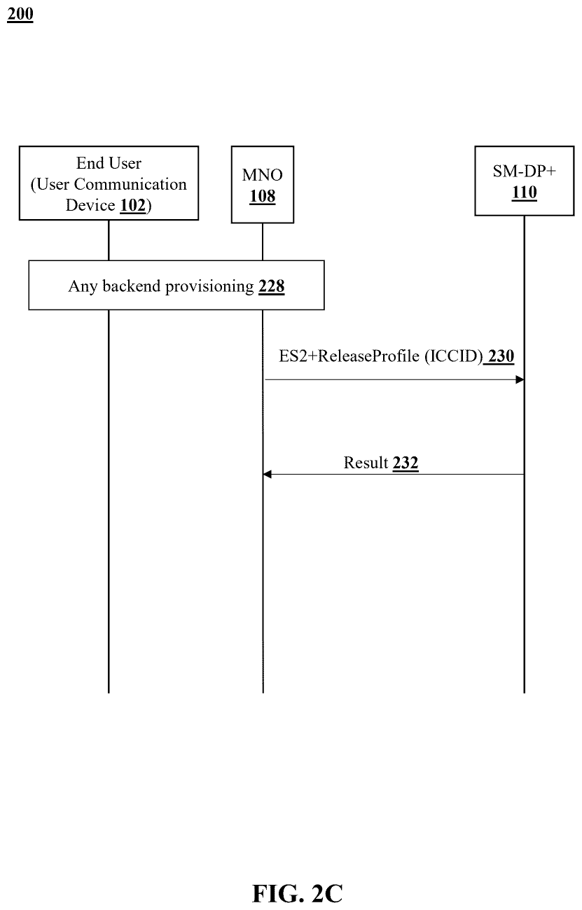

FIGS. 2A-2C illustrate a signaling diagram depicting a method 200 of provisioning of eSIM profiles, in accordance with an embodiment of the present disclosure. The signaling diagram may depict various communication between the user communication device 102 (also referred to as the communication device 102), the MNO 108, and the SM-DP+ 110.

Step 202 may correspond to a contract subscription process between the communication device 102 and the MNO 108. During the contract subscription process, the communication device 102 and the MNO 108 may exchange various information such as, but not limited to, billing information, the EID, device capability information, and so forth.

Step 204 may correspond to an update of a file under a Filesystem that includes a plurality of pre-generated eSIM profiles. The update may be performed based on a request from the MNO 108. Particularly, at step 204, the MNO 108 may transmit an update order function to the SM-DP+ 110. In one example embodiment, the update order function may correspond to ES2+.UpdateOrder. The update order function may include information such as, but not limited to, the EID, an ICCID, an IMSI, an MSISDN, a profile type, a filename, a field, and one or more corresponding updated values. The filename may correspond to a file Identifier (ID). The IMSI may include a home IMSI number and a roaming IMSI number. The filename, the field, and the one or more corresponding updated values may correspond to the filesystem required to store the pre-generated eSIM profiles. The update order function enables the MNO 108 to dynamically update the one or more parameters associated with the pre-generated eSIM profiles during the download/provisioning of the eSIM profiles.

At step 206, the SM-DP+ 110 may select one of a plurality of pre-generated eSIM profiles based on the parameters received in the update order function. For instance, the SM-DP+ 110 may select the eSIM profile based on the EID, the ICCID, and/or the profile type. However, the SM-DP+ 110 may use any other parameter to appropriately select one of the plurality of pre-generated eSIM profiles. In one embodiment, the SM-DP+ may randomly or sequentially select one of the eSIM profiles from the plurality of pre-generated eSIM profiles.

Therefore, the SM-DP+ 110 may perform a set of operations via nested-loop conditions. For instance, if the SM-DP+ 110 is unable to find any eSIM profile via the EID, ICCID, or the profile type, the SM-DP+ 110 may generate an error. The generate may correspond to a generic error similar to ES2+.DownloadOrderFunction. If the SM-DP+ 110 is able to select one of the plurality of pre-generated eSIM profiles and/or a profile state corresponding to one of the plurality of pre-generated eSIM profiles is identified as available, the SM-DP+ 110 may perform further operations. Specifically, the SM-DP+ 110 may determine whether the file corresponding to the selected eSIM profile is present under a Profile element-Generic File Management (PE-GFM) file system or not. If the SM-DP+ 110 determines that the file corresponding to the selected eSIM profile is present, the SM-DP+ 110 will proceed to update the file content of that file. Specifically, the SM-DP+ 110 may update one or more fields of the corresponding file based on the one or more parameters received via the update order function. For instance, the SM-DP+ 110 may update values corresponding to the home IMSI, the roaming IMSI, and the MSISDN. Otherwise, the SM-DP+ 110 may generate an error.

In case, an error is generated due to the failure of any of the above-conditions/operations, the SM-DP+ 110 may transmit an error to the MNO 108, as shown in step 208. The error may be indicative of a failure of the update order function. If the corresponding file and/or the filesystem for the selected eSIM profile is updated successfully, the SM-DP+ may transmit a success indication to the MNO 108, as shown by step 210. The success indication may indicate that the update order function has been successfully executed, and one of the eSIM profiles has been modified based on the one or more parameters provided in the update order function. In one embodiment, with the success indication, the SM-DP+ 110 may transmit the EID, the profile type, and/or the ICCID associated with the updated eSIM profile to the MNO 108. In response to the received success indication, at step 212, the MNO 108 may transmit a download order function to the SM-DP+ 110. In one embodiment, the download order function may correspond to the ES2+.DonwloadOrder( ). The download order function may include one or more parameters including, but not limited to, the EID, the profile type, and/or the ICCID corresponding to the updated eSIM profile. At step 214, the SM-DP+ may reserve the ICCID. In one embodiment, the ICCID may be transmitted to MNO 108 after receiving the download order function, as shown by step 216. In such a case, the MNO 108 may perform a download order function using the EID and/or the profile type.

At step 218, the MNO 108 may generate a matching ID corresponding to the received ICCID. The MNO 108 may also perform any other back-end provisioning required to provide the eSIM profile to the user. In one non-limiting embodiment, the back-end provisioning may include updating event states associated with the eSIM profile.

At step 220, the MNO 108 may transmit a confirm order function to the SM-DP+ 110. The confirm order function may correspond to an ES2+.ConfirmOrder( ) function. The confirm order function may include one or more parameters such as, but not limited to, the ICCID, the EID, the matching ID, a confirmation code, an SM-DS address, and a release flag. In one embodiment, the confirmation code may be shared by the SM-DP+ 110 to the MNO 108 indicating a successful execution of the download order function.

At step 222, the SM-DP+ 110 may generate the matching ID corresponding to the eSIM profile. Next at step 224, the SM-DP+ 110 may transmit the generated matching ID to the MNO 108. In one embodiment, the SM-DP+ 110 may also transmit the SM-DP+address to the MNO 108. Step 226 may correspond to an exchange of information between the MNO 108 and the communication device 102 to perform a contract finalization process. The information may correspond to, but not be limited to, the matching ID, the SM-DP+ server, and/or the confirmation code.

At step 228, the MNO 108 and/or the communication device 102 may perform any other back-end provisioning as required to download the eSIM profile at the communication device 102.

At step 230, the MNO 108 may transmit a release profile function to the SM-DP+ 110. In one embodiment, the release profile function may correspond to ES2+.ReleaseProfile( ) function. The release profile function may include ICCID corresponding to the updated eSIM profile. At step 232, the SM-DP+ 110 may transmit a result of the release profile function to the MNO 108. The result may indicate that the state of the updated eSIM profile has been successfully updated, and the eSIM profile can be installed at the communication device 102.

Therefore, the present disclosure enables the MNO 108 to update the home IMSI, the roaming IMSI, and the MSISDN to the pre-generated eSIM profile. This enables the MNO 108 to re-use the corresponding values as previously used for a disabled physical SIM or an un-provisioned eSIM. This saves a lot of resources and costs for the operator. Moreover, the pre-generated eSIM profile is based on generic parameters and therefore provides flexibility to use in different telecom circles. Also, the MSISDN number may be updated during the eSIM provisioning, preventing dependency on a network for OTA update of the MSISDM. Thus, the present disclosure solves the one or more problems associated with the conventional eSIM architecture and/or workflow.

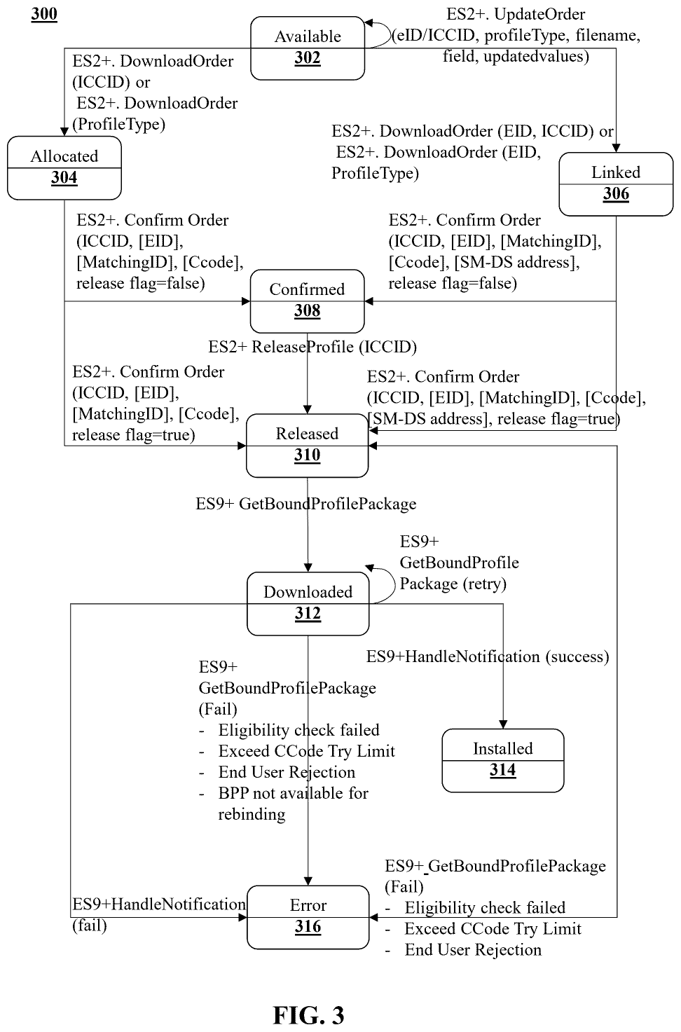

FIG. 3 illustrates a flow diagram 300 illustrating e-SIM profile state transitions during the transferring of the e-SIM profile, according to an embodiment of the present disclosure.

Initially, a pre-generated eSIM profile may be associated with an available state 302. At the available state 302, the SM-DP+ server 110 may receive the ES2+.UpdateOrder( ) function from the MNO 108, as discussed above. In response to the received ES2+.updateorder( ) function, the SM-DP+ server 110 may update the eSIM profile, however, keep the state of the eSIM profile as the available state 302.

In a case, the SM-DP+ server 110 may not receive the ES2+. UpdateOrder( ) function, and receive the ES2+.DownloadOrder( ) function, the SM-DP+ server 110 may change the state of the eSIM profile from the available state 302 to an allocated state 304. In such a scenario, the received ES+.DownloadOrder( ) function may include the ICCID or the profile type as an input parameter.

In another case, when the SM-DP+ server 110 updates the eSIM profile in response to the ES2+.UpdateOrder( ) the SM-DP+ server 110 may update the state of the eSIM profile from the available state 302 to a linked state 306 in response to an ES2+.DownloadOrder function. In such a case, the ES2+.DownloadOrder( ) function may include the EID, and one of the ICCID or the profile type as input parameters.

Thereafter, the SM-DP+ server 110 may receive an ES2+.confirmOrder( ) function. In response to the ES2+.confirmOrder( ) function, the SM-DP+ server 110 may change the state of the eSIM profile to a confirmed state 308. In one embodiment, the ES2+.confirmOrder( ) function may include the ICCID, the EID, the matching ID, the confirmation code, and a release flag as input parameters. The release flag may be marked as false. In another embodiment, the ES2+.confirmOrder( ) function may also include the SM-DS address as one of the input parameters. The SM-DP+ server 110 may then receive an ES2+.ReleaseProfile( ) function from the MNO 108. The ES2+.ReleaseProfile( ) may include the ICCID as an input parameter. In response to the ES2+.ReleaseProfile( ) function, the SM-DP+ server 110 may change the state of the eSIM profile to a released state 310. Alternatively, the SM-DP+ server 110 may directly change the state of the eSIM profile as the released state in response to the ES2+.confirmOrder( ) functions.

Then, the SM-DP+ server 110 may change the state of the eSIM profile to a downloaded state 312 in response to an ES9+.GetBoundProfilePackage( ) function. In case of a failed attempt, the SM-DP+ server 110 may receive an ES9+.GetBoundProfilePackage( ) function with retry as an input parameter.

In case of a successful download and/or an ES9+.HandleNotification( ) function indicating success, the SM-DP+ server 110 may change the state of the eSIM profile to an installed state 314.

However, in case of a failed download, the ES9+.GetBoundProfilePackage( ) function indicating failure, and/or ES9+.HandleNotification( ) function indicating failure, the SM-DP+ server 110 may change the state of the eSIM profile to an error state 316. In one embodiment, the ES9+.GetBoundProfilePackage( ) function may fail due to the following conditions:
Eligibility check failed.
Exceed Confirmation Code (CCode) Try Limit
End User Rejection
Protected Profile Package not available for rebinding

In one embodiment, the SM-DP+ server 110 may change the state of the eSIM profile from the released state 310 to the error state 316 in the case of the ES9+.GetBoundProfilePackage( ) function indicating failure.

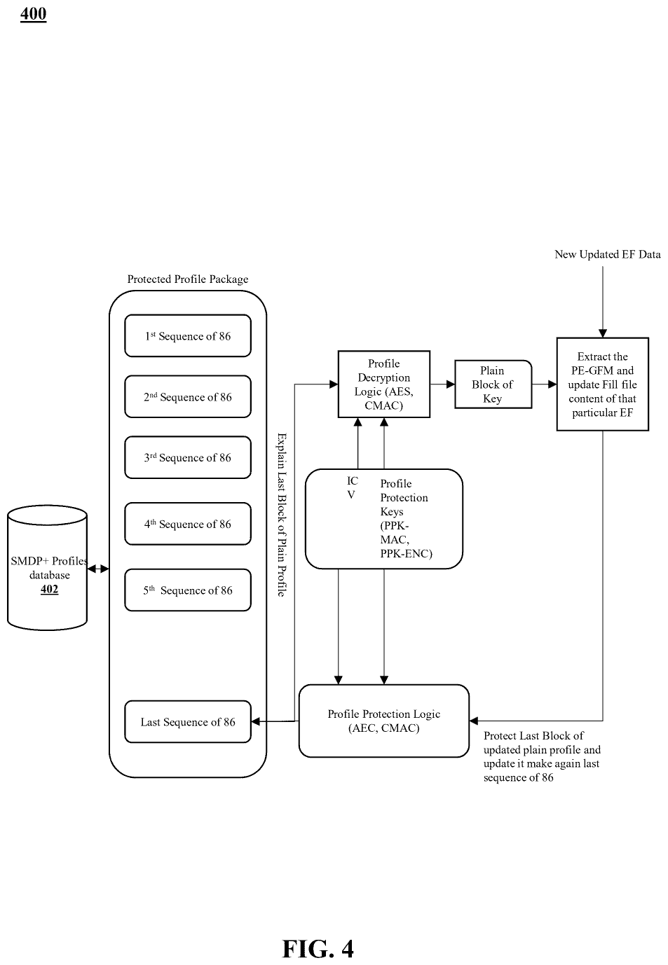

FIG. 4 illustrates a schematic operational flow diagram 400 depicting an eSIM profile update, in accordance with an embodiment of the present disclosure. FIG. 4 illustrates a database 402 which may also be referred to as the SM-DP+profiles database configured to store eSIM profiles generated by the SM-DP+ server 110. Each of the eSIM profiles may be stored in the database 402 as a Protected Profile Package (PPP) including a plurality of sequences of information. In an embodiment, each of the plurality of sequences may correspond to an elementary File (EF) created under PE-GFM. Each of the EFs will be linked to corresponding Dedicated Files (DFs).

In an embodiment, when the SM-DP+ server 110 receives the UpdateOrder (ICCID, File_id,value) function, the SM-DP+ server 110 may pick one pre-generated eSIM Profile which is the PPP Format. In response to the UpdateOrder( ) function, the SM-DP+ server 110 may unwrap the security of a last Profile Block, where files are present which need to be updated. Once the profile block is updated with the newly updated value, the SM-DP+ server 110 may wrap the profile block with the same logic and store in the database 402. In one embodiment, the SM-DP+ server 110 performs predefined decryption and encryption logic to unwrap the profile block and wrap the updated profile block, respectively. In one or more embodiments, the predefined decryption and encryption logics may include, but are not limited to, AES, CMAC, etc.

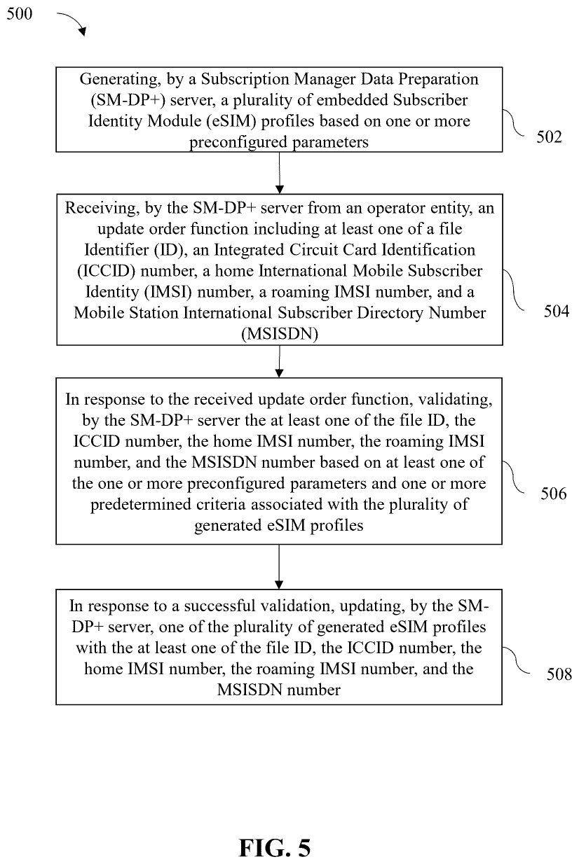

FIG. 5 illustrates a flowchart depicting a method 500 for updating a pre-generated eSIM profile, in accordance with an embodiment of the present disclosure. The method 500 may be performed by the SM-DP+ server 110.

At step 502, the SM-DP+ server 110 may generate a plurality of embedded Subscriber Identity Module (eSIM) profiles based on one or more preconfigured parameters. The one or more preconfigured parameters may include, but are not limited to, a profile type, security credentials, device compatibility information, remote provisioning capabilities, a lifespan, a validity, network configuration parameters, user preferences, and so forth. In one embodiment, each of the plurality of generated eSIM profiles is stored as a protected profile package format in a database (for example, the database 402). The protected profile package includes a plurality of profile blocks. The database 402 may be associated with the SM-DP+ server 110.

At step 504, the SM-DP+ server 110 may receive an update order function (for example, the ES2+.UpdateOrder( )) from an operator entity (for example, the MNO 108). The update order function may include information such as, but not limited to, the file ID, the profile type, the ICCID number, the home IMSI number, the roaming IMSI number, and the MSISDN.

In response to the received update order function, at step 506, the SM-DP+ server 110 may validate one or more of the file ID, the ICCID number, the profile type, the home IMSI number, the roaming IMSI number, and the MSISDN number based on at least one of the one or more preconfigured parameters and one or more predetermined criteria associated with the plurality of generated eSIM profiles. In an embodiment, the SM-DP+ server 110 may identify the values provided in the update order function in the database 402. For instance, the SM-DP+ server 110 may compare and validate one or more of these values with one or more parameters associated with the pre-generated eSIM profiles stored at the database 402 to identify and/or select one of the eSIM profiles. In some embodiments, the one or more predefined criteria may include conditions required to be satisfied to select the eSIM profile. For example, the predefined criteria may indicate a successful validation of the MNO 108. In other examples, the predefined criteria may indicate an exact match of the one or more parameters of the pre-generated eSIM profile with the one or more parameters received in the update order function. However, embodiments of the present disclosure cover or intend to cover any suitable criteria that may be associated with a selection of an eSIM profile.

At step 508, the SM-DP+ server 110 may update the one of plurality of eSIM profiles in response to the successful validation and/or selection of the eSIM profile. The SM-DP+ server 110 may update the eSIM profile with one or more of the file ID, the ICCID number, the home IMSI number, the roaming IMSI number, and the MSISDN number. For instance, the SM-DP+ server 110 may update the corresponding record of the selected eSIM profile with the information received in the update order function. In response to an unsuccessful validation, the SM-DP+ server 110 may generate an error. The error may indicate a rejection to the update order function received from the MNO 108. In one embodiment, the MNO 108 may receive the error and re-initiate the update order function with updated/corrected parameters.

In case of the successful validation, the SM-DP+ server 110 may also transmit an indication to the MNO 108. The indication may indicate successful update of one of the plurality of eSIM profiles based on the received update order function.

The SM-DP+ server 110 may also receive the download order function from the MNO 108. The download order function may include information such as, but not limited to, the EID, the profile type, and the ICCID. Further, the SM-DP+ server 110 may transmit at least one of a corresponding ICCID and a matching ID associated with the updated one of the plurality of eSIM profiles to the MNO 108. In one embodiment, the transmission of the ICCID or the matching ID may be based on the received at least one of the EID, the profile type, and the ICCID.

The SM-DP+ server 110 may also receive a confirm order function from the MNO 108. The confirm order function may include one or more of the EID, the ICCID, the matching ID, a confirmation code, a Subscription Manager-Discovery Server (SMDS) address, and a release flag corresponding to the updated one of the plurality of eSIM profiles. In response to the received confirm order function, the SM-DP+ server 110 may transmit one of the Matching ID or a SM-DS address to the MNO 108. In one embodiment, the matching ID is provided to a user device to download the updated one of the plurality of the eSIM profiles.

In one embodiment, the SM-DP+ server 110 may decrypt a last profile block among the plurality of profiles associated with the one of the plurality of eSIM profiles. Further, the SM-DP+ server 110 may update the decrypted last profile block with one or more of the file ID, the ICCID number, the home IMSI number, the roaming IMSI number, and the MSISDN number. Thereafter, the SM-DP+ server 110 may encrypt the updated last profile block and store in the database 402.

While the above-discussed steps in FIG. 5 are shown and described in a particular sequence, the steps may occur in variations to the sequence in accordance with various embodiments. Further, a detailed description related to the various steps of FIG. 5 is already covered in the description related to FIGS. 2-4 and is omitted herein for the sake of brevity.

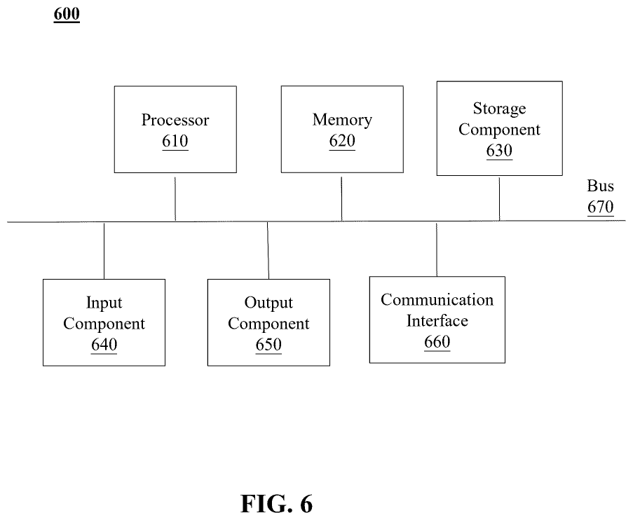

FIG. 6 is a diagram of example components of a wireless communication device 600 (also referred to as the device/apparatus 600), in accordance with an embodiment of the present disclosure. In one or more embodiments, the wireless communication device 600 may correspond to the communication device 102, the MNO 108, or the SM-DP+ server 110. As shown in FIG. 6, the device 600 includes a processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single-core processor, or a combination of one or more multi-core processors and/or one or more single-core processors, a distributed processing system, or the like. The processor 610 may be a Central Processing Unit (CPU), a Graphics Processing Unit (GPU), an Accelerated Processing Unit (APU), an Application-Specific Integrated Circuit (ASIC), or another type of processing component.

The memory 620 includes a non-transitory computer-readable medium. The memory 620 includes a Random-Access Memory (RAM), a Read Only Memory (ROM), and/or another type of dynamic or static storage device (e.g., a flash memory, a magnetic memory, and/or an optical memory) that stores information and/or instructions for use by the processor 610. The memory 620 comprises machine-readable instructions which are executable by the processor 610. These machine-readable instructions when executed by the processor 610 cause the processor 610 to perform one or more method steps of an embodiment described above.

The storage component 630 stores information and/or software related to the operation and use of the device 600. For example, the storage component 630 may include a hard disk (e.g., a magnetic disk, an optical disk, a magneto-optic disk, and/or a solid-state disk), a Compact Disc (CD), a Digital Versatile Disc (DVD), a floppy disk, a cartridge, a magnetic tape, and/or another type of non-transitory computer-readable medium, along with a corresponding drive.

The input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a Global Positioning System (GPS), an accelerometer, a gyroscope, and/or an actuator).

The output component 650 is configured to provide output information from the device 600. For example, the output component 650 maybe, but is not limited to, a display, a speaker, an instruction device to an external device, and/or one or more Light-Emitting Diodes (LEDs).

The communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, the device 600 may include additional components, fewer components, different components, or differently arranged components than those shown in FIG. 6. Additionally, or alternatively, a set of components (e.g., one or more components) of the device 600 may perform one or more functions described as being performed by another set of components of the device 600. Further, one or more method steps described in any of the embodiments may be performed utilizing a plurality of devices 600 in communication with one another.

It is understood that terms including “unit” or “module” at the end may refer to the unit for processing at least one function or operation and may be implemented in hardware, software, or a combination of hardware and software.

In one embodiment, an apparatus is described. The apparatus is configured to generate a plurality of embedded Subscriber Identity Module (eSIM) profiles based on one or more preconfigured parameters. The apparatus is also configured to receive, from an operator entity, an update order function including at least one of a file Identifier (ID), a profile type, an Integrated Circuit Card Identification (ICCID) number, a home International Mobile Subscriber Identity (IMSI) number, a roaming IMSI number, and a Mobile Station International Subscriber Directory Number (MSISDN). In response to the received update order function. The apparatus is configured to validate the at least one of the file ID, the ICCID number, the profile type, the home IMSI number, the roaming IMSI number, and the MSISDN number based on at least one of the one or more preconfigured parameters and one or more predetermined criteria associated with the plurality of generated eSIM profiles. In response to a successful validation, the apparatus is configured to update one of the plurality of generated eSIM profiles with the at least one of the file ID, the ICCID number, the home IMSI number, the roaming IMSI number, and the MSISDN number.

The apparatus as described in [0072], wherein in response to an unsuccessful validation, the apparatus is configured to generate an error indicating a rejection to the update order function.

The apparatus as described in and [0073], wherein in response to the successful validation, the apparatus is further configured to transmit, to the operator entity, an indication for successful update of the one of the plurality of eSIM profiles based on the received update order function.

The apparatus as described in any of to [0074], further configured to:
receive, from the operator entity, a download order function including at least one of an Embedded Identity Document (EID), a profile type, and an ICCID corresponding to the updated one of the plurality of eSIM profiles; and
transmit, to the operator entity, at least one of a corresponding ICCID and a matching ID associated with the updated one of the plurality of eSIM profiles based on the received at least one of the EID, the profile type, and the ICCID.

The apparatus as described in any of [0072] to [0075], is further configured to:
receive, from the operator entity, a confirm order function including at least one of the EID, the ICCID, the matching ID, a confirmation code, a Subscription Manager-Discovery Server (SMDS) address, and a release flag corresponding to the updated one of the plurality of eSIM profiles; and
transmit, to the operator entity, at least one of the Matching ID and a Subscription Manager Data Preparation (SM-DP) address,
wherein the matching ID is provided to a user device to download the updated one of the plurality of the eSIM profiles.

The apparatus as described in any of [0072] to [0076], wherein each of the plurality of generated eSIM profiles is stored as a protected profile package format in a database, the protected profile package including a plurality of profile blocks.

The apparatus as described in any of [0072] to [0077], wherein to update the one of the plurality of generated eSIM profiles, the apparatus is configured to:
decrypt a last profile block among the plurality of profile blocks associated with the one of the plurality of eSIM profiles;
update the decrypted last profile block with the at least one of the file ID, the ICCID number, the home IMSI number, the roaming IMSI number, and the MSISDN number; and
encrypt the updated last profile block and store in the database.

The apparatus as described in any of [0072] to [0078], wherein at least one of the home IMSI number, the roaming IMSI number, and the MSISDN number correspond to one of a physical SIM and an eSIM.

The apparatus as described in any of [0072] to [0079], the apparatus corresponds to a Subscription Manager Data Preparation (SM-DP+) server.

In one embodiment, a method is described. The method includes generating, by a Subscription Manager Data Preparation (SM-DP+) server, a plurality of embedded Subscriber Identity Module (eSIM) profiles based on one or more preconfigured parameters. The method also includes generating, by a Subscription Manager Data Preparation (SM-DP+) server, a plurality of embedded Subscriber Identity Module (eSIM) profiles based on one or more preconfigured parameters. The method includes receiving, by the SM-DP+ server from an operator entity, an update order function including at least one of a file Identifier (ID), an Integrated Circuit Card Identification (ICCID) number, a home International Mobile Subscriber Identity (IMSI) number, a roaming IMSI number, and a Mobile Station International Subscriber Directory Number (MSISDN). In response to the received update order function, the method includes validating, by the SM-DP+ server, the at least one of the file ID, the ICCID number, the home IMSI number, the roaming IMSI number, and the MSISDN number based on at least one of the one or more preconfigured parameters and one or more predetermined criteria associated with the plurality of generated eSIM profiles. In response to a successful validation, the method includes updating, by the SM-DP+ server, one of the plurality of generated eSIM profiles with the at least one of the file ID, the ICCID number, the home IMSI number, the roaming IMSI number, and the MSISDN number.

The method as described in [0081], wherein in response to an unsuccessful validation, the method further comprises generating an error indicating a rejection to the update order function.

The method as described in any of [0081] to [0082], wherein in response to the successful validation, the method further comprises transmitting, by the SM-DP+ server to the operator entity, an indication for successful update of the one of the plurality of eSIM profiles based on the received update order function.

The method as described in any of [0081] to [0083], further comprising:
receiving, by the SM-DP+ server from the operator entity, a download order function including at least one of an Embedded Identity Document (EID), a profile type, and an ICCID corresponding to the updated one of the plurality of eSIM profiles; and
transmitting, by the SM-DP+ server to the operator entity, at least one of a corresponding ICCID and a matching ID associated with the updated one of the plurality of eSIM profiles based on the received at least one of the EID, the profile type, and the ICCID.

The method as described in any of [0081] to [0084], wherein after transmitting the at least one of the corresponding ICCID and the matching ID associated with the updated one of the plurality of eSIM profiles, the method comprises:
receiving, by the SM-DP+ server from the operator entity, a confirm order function including at least one of the EID, the ICCID, the matching ID, a confirmation code, a Subscription Manager-Discovery Server (SMDS) address, and a release flag corresponding to the updated one of the plurality of eSIM profiles; and
transmitting, by the SM-DP+ server to the operator entity, at least one of the Matching ID and a Subscription Manager Data Preparation (SM-DP) address,
wherein the matching ID is provided to a user device to download the updated one of the plurality of the eSIM profiles.

The method as described in any of [0081] to [0085], wherein each of the plurality of generated eSIM profiles is stored as a protected profile package format in a database, the protected profile package including a plurality of profile blocks.

The method as described in any of [0081] to [0086], wherein for updating the one of the plurality of generated eSIM profiles, the method comprises:
decrypting a last profile block among the plurality of profile blocks associated with the one of the plurality of eSIM profiles;
updating the decrypted last profile block with the at least one of the file ID, the ICCID number, the home IMSI number, the roaming IMSI number, and the MSISDN number; and
encrypting the updated last profile block and store in the database.

The method as described in any of [0081] to [0087], wherein at least one of the home IMSI number, the roaming IMSI number, and the MSISDN number corresponds to one of a physical SIM and an eSIM.

In one embodiment, a non-transitory computer-readable medium storing instructions is described. The instructions comprising: one or more instructions that, when executed by a Subscription Manager Data Preparation (SM-DP+) server. The SM-DP+ server comprises one or more processors. The instructions cause the one or more processors to generate a plurality of embedded Subscriber Identity Module (eSIM) profiles based on one or more preconfigured parameters. The instructions cause the one or more processors to receive, from an operator entity, an update order function including at least one of a file Identifier (ID), an Integrated Circuit Card Identification (ICCID) number, a home International Mobile Subscriber Identity (IMSI) number, a roaming IMSI number, and a Mobile Station International Subscriber Directory Number (MSISDN). In response to the received update order function, the instructions cause the one or more processors to validate the at least one of the file ID, the ICCID number, the home IMSI number, the roaming IMSI number, and the MSISDN number based on at least one of the one or more preconfigured parameters and one or more predetermined criteria associated with the plurality of generated eSIM profiles. In response to a successful validation, the instructions cause the one or more processors to update one of the plurality of generated eSIM profiles with the at least one of the file ID, the ICCID number, the home IMSI number, the roaming IMSI number, and the MSISDN number.

The non-transitory computer-readable medium as described in [0089], wherein in response to an unsuccessful validation, the one or more instructions cause the one or more processors to generate an error indicating a rejection to the update order function.

The non-transitory computer-readable medium as described in [0089] or [0090], wherein in response to the successful validation, the one or more instructions cause the one or more processors to transmit, to the operator entity, an indication for successful update of the one of the plurality of eSIM profiles based on the received update order function.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

The foregoing description of the specific embodiments will so fully reveal the general nature of the embodiments herein that others can, by applying current knowledge, readily modify and adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of at least one embodiment, those skilled in the art will recognize that the embodiments herein can be practiced with modification within the spirit and scope of the embodiments as described herein.

We claim:

1. An apparatus configured to:
generate a plurality of embedded Subscriber Identity Module (eSIM) profiles based on one or more preconfigured parameters;
receive, from an operator entity, an update order function including at least one of a file Identifier (ID), a profile type, an Integrated Circuit Card Identification (ICCID) number, a home International Mobile Subscriber Identity (IMSI) number, a roaming IMSI number, and a Mobile Station International Subscriber Directory Number (MSISDN);
in response to the received update order function, validate the at least one of the file ID, the ICCID number, the profile type, the home IMSI number, the roaming IMSI number, and the MSISDN number based on at least one of the one or more preconfigured parameters and one or more predetermined criteria associated with the plurality of generated eSIM profiles; and
in response to a successful validation, update one of the plurality of generated eSIM profiles with the at least one of the file ID, the ICCID number, the home IMSI number, the roaming IMSI number, and the MSISDN number.

2. The apparatus as claimed in claim 1, wherein in response to an unsuccessful validation, the apparatus is configured to generate an error indicating a rejection to the update order function.

3. The apparatus as claimed in claim 1, wherein in response to the successful validation, the apparatus is further configured to:
transmit, to the operator entity, an indication for successful update of the one of the plurality of eSIM profiles based on the received update order function.

4. The apparatus as claimed in claim 1, further configured to:
receive, from the operator entity, a download order function including at least one of an Embedded Identity Document (EID), a profile type, and an ICCID corresponding to the updated one of the plurality of eSIM profiles; and
transmit, to the operator entity, at least one of a corresponding ICCID and a matching ID associated with the updated one of the plurality of eSIM profiles based on the received at least one of the EID, the profile type, and the ICCID.

5. The apparatus as claimed in claim 4, further configured to:
receive, from the operator entity, a confirm order function including at least one of the EID, the ICCID, the matching ID, a confirmation code, a Subscription Manager-Discovery Server (SMDS) address, and a release flag corresponding to the updated one of the plurality of eSIM profiles; and
transmit, to the operator entity, at least one of the Matching ID and a Subscription Manager Data Preparation (SM-DP) address,
wherein the matching ID is provided to a user device to download the updated one of the plurality of the eSIM profiles.

6. The apparatus as claimed in claim 1, wherein each of the plurality of generated eSIM profiles is stored as a protected profile package format in a database, the protected profile package including a plurality of profile blocks.

7. The apparatus as claimed in claim 5, wherein to update the one of the plurality of generated eSIM profiles, the apparatus is configured to:
decrypt a last profile block among the plurality of profile blocks associated with the one of the plurality of eSIM profiles;
update the decrypted last profile block with the at least one of the file ID, the ICCID number, the home IMSI number, the roaming IMSI number, and the MSISDN number; and
encrypt the updated last profile block and store in the database.

8. The apparatus as claimed in claim 1, wherein at least one of the home IMSI number, the roaming IMSI number, and the MSISDN number correspond to one of a physical SIM and an eSIM.

9. The apparatus as claimed in claim 1, the apparatus corresponds to a Subscription Manager Data Preparation (SM-DP+) server.

10. A method comprising:
generating, by a Subscription Manager Data Preparation (SM-DP+) server, a plurality of embedded Subscriber Identity Module (eSIM) profiles based on one or more preconfigured parameters;
receiving, by the SM-DP+ server from an operator entity, an update order function including at least one of a file Identifier (ID), an Integrated Circuit Card Identification (ICCID) number, a home International Mobile Subscriber Identity (IMSI) number, a roaming IMSI number, and a Mobile Station International Subscriber Directory Number (MSISDN);
in response to the received update order function, validating, by the SM-DP+ server, the at least one of the file ID, the ICCID number, the home IMSI number, the roaming IMSI number, and the MSISDN number based on at least one of the one or more preconfigured parameters and one or more predetermined criteria associated with the plurality of generated eSIM profiles; and
in response to a successful validation, updating, by the SM-DP+ server, one of the plurality of generated eSIM profiles with the at least one of the file ID, the ICCID number, the home IMSI number, the roaming IMSI number, and the MSISDN number.

11. The method as claimed in claim 10, wherein in response to an unsuccessful validation, the method further comprises generating an error indicating a rejection to the update order function.

12. The method as claimed in claim 10, wherein in response to the successful validation, the method further comprises:
transmitting, by the SM-DP+ server to the operator entity, an indication for successful update of the one of the plurality of eSIM profiles based on the received update order function.

13. The method as claimed in claim 10, further comprising:
receiving, by the SM-DP+ server from the operator entity, a download order function including at least one of an Embedded Identity Document (EID), a profile type, and an ICCID corresponding to the updated one of the plurality of eSIM profiles; and
transmitting, by the SM-DP+ server to the operator entity, at least one of a corresponding ICCID and a matching ID associated with the updated one of the plurality of eSIM profiles based on the received at least one of the EID, the profile type, and the ICCID.

14. The method as claimed in claim 10, wherein after transmitting the at least one of the corresponding ICCID and the matching ID associated with the updated one of the plurality of eSIM profiles, the method comprises:
receiving, by the SM-DP+ server from the operator entity, a confirm order function including at least one of the EID, the ICCID, the matching ID, a confirmation code, a Subscription Manager-Discovery Server (SMDS) address, and a release flag corresponding to the updated one of the plurality of eSIM profiles; and
transmitting, by the SM-DP+ server to the operator entity, at least one of the Matching ID and a Subscription Manager Data Preparation (SM-DP) address,
wherein the matching ID is provided to a user device to download the updated one of the plurality of the eSIM profiles.

15. The method as claimed in claim 10, wherein each of the plurality of generated eSIM profiles is stored as a protected profile package format in a database, the protected profile package including a plurality of profile blocks.

16. The method as claimed in claim 15, wherein for updating the one of the plurality of generated eSIM profiles, the method comprises:
decrypting a last profile block among the plurality of profile blocks associated with the one of the plurality of eSIM profiles;
updating the decrypted last profile block with the at least one of the file ID, the ICCID number, the home IMSI number, the roaming IMSI number, and the MSISDN number; and
encrypting the updated last profile block and store in the database.

17. The method as claimed in claim 10, wherein at least one of the home IMSI number, the roaming IMSI number, and the MSISDN number correspond to one of a physical SIM and an eSIM.

18. A non-transitory computer-readable medium storing instructions, the instructions comprising: one or more instructions that, when executed by a Subscription Manager Data Preparation (SM-DP+) server, the SM-DP+ server comprising one or more processors, cause the one or more processors to:
generate a plurality of embedded Subscriber Identity Module (eSIM) profiles based on one or more preconfigured parameters;
receive, from an operator entity, an update order function including at least one of a file Identifier (ID), an Integrated Circuit Card Identification (ICCID) number, a home International Mobile Subscriber Identity (IMSI) number, a roaming IMSI number, and a Mobile Station International Subscriber Directory Number (MSISDN);
in response to the received update order function, validate the at least one of the file ID, the ICCID number, the home IMSI number, the roaming IMSI number, and the MSISDN number based on at least one of the one or more preconfigured parameters and one or more predetermined criteria associated with the plurality of generated eSIM profiles; and
in response to a successful validation, update one of the plurality of generated eSIM profiles with the at least one of the file ID, the ICCID number, the home IMSI number, the roaming IMSI number, and the MSISDN number.

19. The non-transitory computer-readable medium as claimed in claim 18, wherein in response to an unsuccessful validation, the one or more instructions cause the one or more processors to: generate an error indicating a rejection to the update order function.

20. The non-transitory computer-readable medium as claimed in claim 18, wherein in response to the successful validation, the one or more instructions cause the one or more processors to:
transmit, to the operator entity, an indication for successful update of the one of the plurality of eSIM profiles based on the received update order function.
